(19) United States
(12) Patent Application Publication
(10) Pub. No.: US 2007/0087110 A1
(43) Pub. Date: Apr. 19, 2007

(54) METHOD AND APPARATUS FOR MAKING LONG-SLICED POTATO CHIPS

(76) Inventor: Edward Pilla, Warrenton, MO (US)

Correspondence Address: SENNIGER POWERS, ONE METROPOLITAN SQUARE, 16TH FLOOR, ST LOUIS, MO, 63102, US

(21) Appl. No.: 11/564,979

(22) Filed: Nov. 30, 2006

Related U.S. Application Data
(63) Continuation-in-part of application No. 10/369,001, filed on Feb. 19, 2003.

(51) Int. Cl. A23L 1/216

(52) U.S. Cl. 426/637

(57) ABSTRACT

A method of making long-sliced deep-fried potato chips from whole, raw potatoes having an elongate shape and an apparatus for performing the method; the method comprising providing a horizontally elongated mesh strainer in a vat holding a bath of cooking oil and heating the cooking oil to a pre-selected frying temperature; loading the potatoes into a slicing mechanism at one end of the vat of cooking oil with the long potato dimension being oriented to correspond to that of the mesh strainer, moving the slicing mechanism back and forth over the vat of cooking oil and concurrently slicing the potatoes in the long dimension thereof to dispense raw potato slices to fall into the cooking oil in a scattered manner, deep-frying the potato slices into potato chips during a controlled cooking sequence and removing the mesh strainer from the cooking oil. The method further comprises processing the potato chips for marketing such chips by seasoning and dehydrating.

### CROSS-REFERENCE TO RELATED APPLICATION

This is a continuation-in-part of U.S. application Ser. No. 10/369,001 filed Feb. 19, 2003 for Method And Apparatus For Producing And Selling Potato Chips, the entire disclosure of which is incorporated herein by reference.

### FIELD OF THE INVENTION

The invention relates generally to methods and apparatus for cooking and marketing certain fried food products, and more particularly, it pertains to improvements in making potato chips.

### BACKGROUND OF THE INVENTION

The identification, gathering, preparation and dispensing of food is most basic to the human race. Beyond nutritional requirements per se, demands for better flavor, more rapid preparation and elegant presentation have dominated the directions taken in the development of food processing and equipment therefor. In today's society, there is a constant demand for better snack products and fast food service, and such demands have generated a plethora of new equipment and methods for producing distinctive or identifiable food product forms and tastes to satisfy every hunger whim.

Potatoes are universally recognized as being a dietary staple, and have a vast number of preparation and presentation forms that utilize variety differences which include (1) color—ranging from white through yellow and orange to red and (2) size—ranging from huge, elongate potatoes such as the Russets and Alturas through very small round chipping potatoes such as the Atlantic, Nordic and Shephardy and (3) flavor which varies widely and is influenced by water content/specific gravity and sugar/starch ratios. For instance, it is known that lower sugar content produces lighter and better coloration.

Potato chips have evolved as a favorite food form throughout the world, and a great amount of development work has been done in equipment and processes for making such products.

Smith U.S. Pat. No. 5,394,790 is of interest in disclosing a semi-automatic potato chip making system in which potatoes are randomly loaded in the hopper of a slicing machine which is manually moved by an operator to a fixed slicing position where potatoes are sliced directly into the cooking oil. The operator monitors the cooking process and determines when the chips are cooked, then manually actuates a scoop to remove the chips for draining, seasoning and packaging. Smith does not teach long potato orientation, reciprocating slicing machine movement to dispense potato slices into the oil in a scattered pattern, automatic monitoring of oil temperature to maintain a minimum cooking temperature; and providing “set” and “cooking” sequences, enfolding and depressing the frying chips into the oil during the cooking sequence, or automatically removing the deep-fried chips at a preselected time for draining, seasoning and dehydration.

Frank U.S. Pat. No. 5,193,440 is also of interest in discussing basic nomenclature for domestic and foreign identification—i.e. “potato chips” in the United States and “potato crisps” in Great Britain. Frank teaches the construction and operation of several species of apparatus useful for domestic (i.e. household) potato chip making where a single potato may be processed to make a few slices or “chips”; and Frank is also instructive in suggesting certain parameters and distinguishing differences between industrial potato chip manufacture and such domestic potato chip production. It may be here noted that large scale continuous potato chip manufacture of an “industrial” magnitude using so-called “chipping” potatoes is vastly different from the present invention as is the domestic making of a small potato chip batch consisting of a few chips.

Other prior art also falls short of teaching the present invention, which pertains to the production of batches of very large deep-fried potato chips, and their marketing at public “entertainment” venues and the like.

Various mass meeting events or locations, such as conventions, carnivals, fairs, sporting events, musical events, amusement parks, and the like often have booths, kiosks, or counters for providing various food and beverage items to people attendant at such events or locations. The present invention provides a method and apparatus for producing elegant and interesting deep-fried potato chips and for marketing these potato chips at such events or locations. Using the apparatus of the invention the production of potato chips themselves becomes an attraction that entices consumers to purchase potato chips.

### SUMMARY OF THE INVENTION

In a first aspect, the method of the invention comprises the steps of producing deep-fried potato chips, displaying particular steps of the production to a potential consumer, and selling deep-fried potato chips to the consumer. The production of the deep-fried potato chips comprises displaying and loading whole raw elongated potatoes into a slicing mechanism and slicing the potato into a plurality of raw potato slices above a volume of heated oil in a manner such that gravity causes the raw potato slices to fall in a dispersed pattern into the heated oil, converting the raw potato slices into deep-fried potato chips via the heated oil, and removing the deep-fried potato chips from the heated oil. The steps of slicing, converting (i.e. cooking), and removing are performed automatically. The step of displaying the production comprises displaying the loading and slicing and the removing steps to interested potential consumers to entice the potential purchase of deep-fried potato chips and occurs by direct line-of-sight. Finally, the step of selling deep-fried potato chips to consumers ideally occurs within fifty feet of the production of deep-fried potato chips.

In a second aspect, a method of practicing the invention comprises the steps of providing a deep-fried potato chip production device, orienting whole, raw potatoes relative to the long dimension thereof, slicing a plurality of raw potatoes into a plurality of elongate raw potato slices, and cooking the raw potato slices into deep-fried potato chips. The production device comprises a slicing mechanism, a bath of heated oil with time and temperature cooking controls, a strainer, and an electronic control unit. The slicing occurs over the bath of heated oil while the slicing mechanism and the plurality of raw potatoes are moving in a reciprocating manner relative to the bath of heated oil so that the raw potato slices fall by gravity into the bath of heated oil in a dispersed manner. The moving of the slicing mechanism and the slicing sequences are automatically controlled by the control unit. The converting or cooking of the raw potato slices into deep-fried potato chips occurs in the bath of heated oil. The method also comprises removing the deep-fried potato chips from the bath of heated oil by raising the strainer out of the bath of heated oil as controlled by the control unit.

In yet another aspect of the invention, an apparatus comprises a cooking oil container with a two temperature heat control, a potato slicing mechanism, a mesh strainer, and an electronic control unit. The cooking oil container contains a bath of cooking oil and the heat source is adapted to maintain optimum “set” and “cooking” heat in the bath of cooking oil. The potato slicing mechanism is configured and adapted to hold a vertical stack of whole raw potatoes and is operatively connected to slice the raw potatoes over the cooking oil container in a manner such that the potato slicing mechanism is capable of reciprocating movement to scatter the slices across the surface of the cooking oil. The strainer is operatively connected to the cooking oil container to be movable into and out of the bath of cooking oil in cooking and draining sequences, and to be foldable or closable during the cooking sequence to enhance the chip-frying sequence. The electronic control unit is operatively connected to the potato slicing mechanism and the strainer in a manner such that the electronic control unit controls the reciprocating movement of the potato slicing mechanism and the folding and removal movements of the strainer.

The principal object of the present invention is to provide a method and apparatus for making and selling large long-sliced potato chips, especially in public venues.

Another object is to provide a potato chip apparatus that is transportable to different venues and movable therein for optimum production and marketing strategy.

Still another object is to select and load the largest available raw potatoes into the slicing mechanism of a potato chip making apparatus so as to produce the longest sliced potato chips possible.

Another object is to operate the slicing mechanism along the top of the cooking oil vat so potato slices fall in a dispersion pattern to avoid clumping, and to stir or otherwise control the potato slices during cooking.

While the principal advantages and features of the invention have been described above, additional features and advantages may be obtained by referring to the drawings and the following detailed description of the preferred embodiment.

### BRIEF DESCRIPTION OF THE DRAWINGS

FIG. 1 is perspective view of a potato chip production device in accordance with the invention, the device being shown with a strainer in its lowest position and with a potato slicing mechanism in an intermediate travel position.

FIG. 2 is a perspective view of the potato chip production device shown in FIG. 1, and is shown with the slicing mechanism in a remote “parked” potato loading position and with the strainer in a raised position.

FIG. 3 is a perspective view of the potato chip production device shown in FIGS. 1 and 2, and is shown with the strainer pivoted to a position for the removal of potato chips therefrom.

FIG. 4 is an enlarged fragmentary view of the slicing mechanism and movable carriage of FIG. 2.

FIG. 5 is a enlarged fragmentary cross-sectional view of the potato slicing mechanism as taken substantially along line 5-5 of FIG. 4,

FIG. 6 is another greatly enlarged fragmentary cross-section of the potato slicing mechanism loading bin as taken along line 6-6 of FIG. 5,

FIG. 7A is a greatly enlarged diagrammatic perspective view, to illustrating a modified basket support and guidance frame used in the method of the invention;

FIG. 7B is an enlarged diagrammatic perspective view illustrating the modified basket strainer used with the FIG. 7A support frame;

FIG. 8 is an enlarged perspective view of the modified and assembled basket strainer and support frame and showing the foldable strainer side walls in partially folded condition;

FIG. 9 is an end elevation of the lever control end plate for the foldable basket looking along line 9-9 of FIG. 8 and shown in an open potato slice receiving position; and

FIG. 10 is a view similar to FIG. 9 showing the lever control end plate as in a closed chip depressing and cooking position.

Reference characters in the written specification indicate corresponding items shown throughout the drawing figures.

### DETAILED DESCRIPTION OF THE PREFERRED EMBODIMENT OF THE INVENTION

In accordance with the invention, a preferred embodiment of a potato chip production device is generally indicated by the reference numeral 10. The potato chip production device 10 comprises a main body portion 12, a potato slicing mechanism 14, and a strainer section 16.

The main body portion 12 of the potato chip production device 10 preferably has a box-shaped frame assembly which contains and supports a cooking oil container 18, a heat source (not shown) for internally heating the oil in the container 18, and an exhaust plenum 20. The cooking oil container 18 is open on its topside and is adapted to hold a relatively large bath of cooking oil for deep-frying potato chips therein. The heat source is preferably a propane burner positioned beneath the cooking oil container 18. The main body portion 12 is constructed and arranged so that the combustion byproducts of the heat source are discharged through the exhaust plenum 20 and safely exit into the external environment at a sufficient height to avoid interfering with the operation of the rest of the production device 10. Due to the heat generated by the heat source and dissipated from the bath of heated oil in the cooking oil container 18, the main body portion 12 also preferably has an exterior paneling 22 that surrounds the majority of its periphery and is spaced from the cooking oil container to shield persons near the device from excessive heat. The potato chip making device 10 is mounted on four wheels 38 at the corners of the frame assembly of the main body portion 12 to accommodate movement or repositioning on its ground support surface.

In addition to its basic components, the main body portion 12 of the potato chip manufacturing device 10 also comprises a support rack 24 for supporting and guiding the reciprocating movement of the slicing mechanism 14 and an electronic control unit 26.

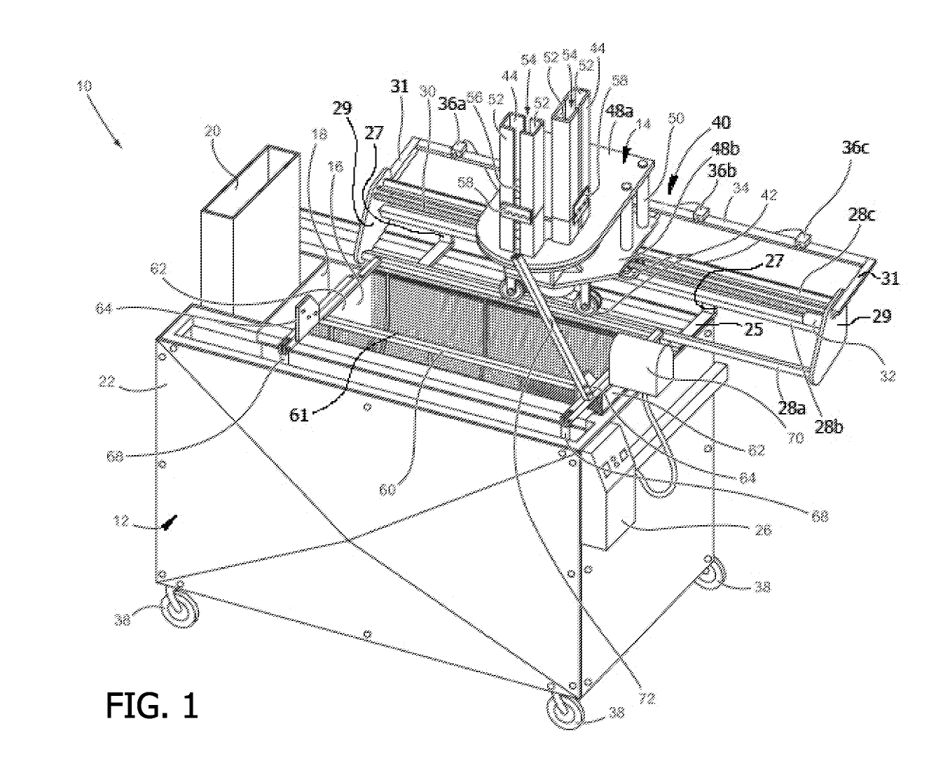

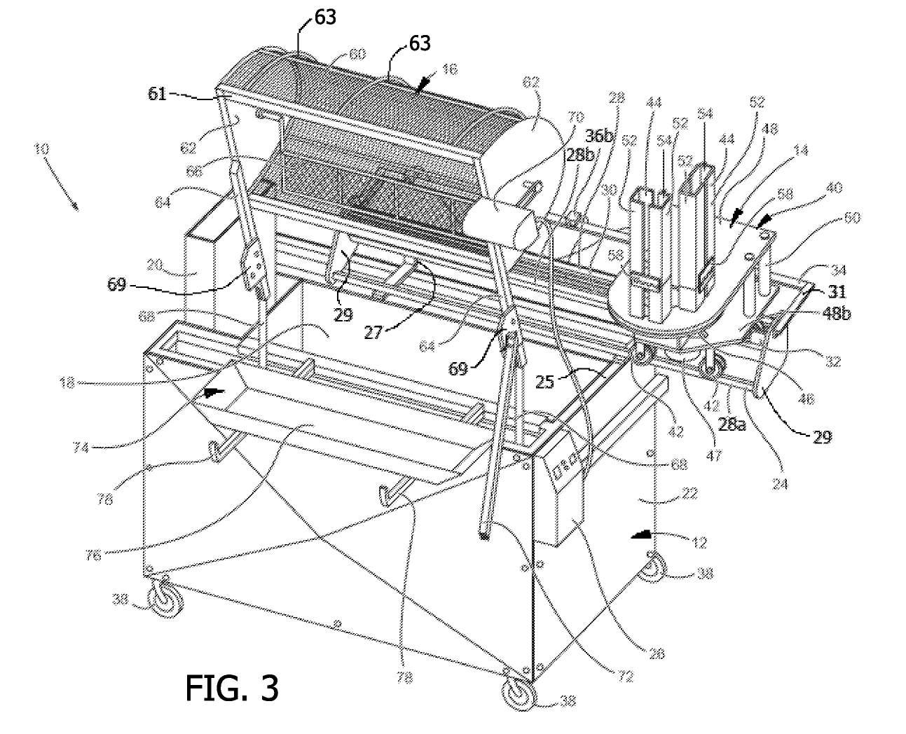

The support rack 24 includes a peripheral top structural frame 25 around the main body portion 12, and supports three parallel guide rails 28a, 28b and 28c extending longitudinally thereof, FIG. 3. The front rail 28a is secured to the peripheral frame 25 and the rearward rail 28b is secured by vertical risers 27 to this frame so as to extend longitudinally of the main body 12 at a slightly higher level than the front rail 28a, FIG. 1. The rails 28a and 28b are also rigidly connected together by end brackets 29, and the third parallel rail 28c also connects to the end brackets 29 and lies along a rearward and more elevated horizontal line than rails 28a and 28b. A threaded drive rod 30 has its ends journalled in the end brackets 29, and has an electromechanical drive rod motor 32. A sensor or travel limiting switch support beam 34 is attached by frame pieces 31, FIG. 1, to extend parallel to the rails 28a-28c. As will appear, the drive rod motor 32 is mounted below the slicing machine carriage and rotationally spins or turns the drive rod 30 to move the slicing mechanism carriage from an inoperatable remote or parked potato loading station—at the right-hand end of the support rack 24—longitudinally of the main frame 12 along the guide rails 28a-28c to the left-hand end of the support rack in an operative slicing sequence.

It will be noted with particular reference to FIG. 3, that the entire support rack 24 and slicing mechanism carriage (14) is mounted on the main body portion 12 along the rearward wall adjacent to the rear side of the cooking container 18. It should also be noted in the drawings that the relative movement or travel of the slicing mechanism in its operative slicing sequences is determined by three electromechanical sensors or travel limiting switches 36a, 36b and 36c that are secured to the sensor support beam 34 along its length. The control unit 26 is operatively connected to each of the sensors (36), to the heat source beneath the cooking oil container 18, and to the drive rod motor 32 as well as the strainer or section 16, as will appear.

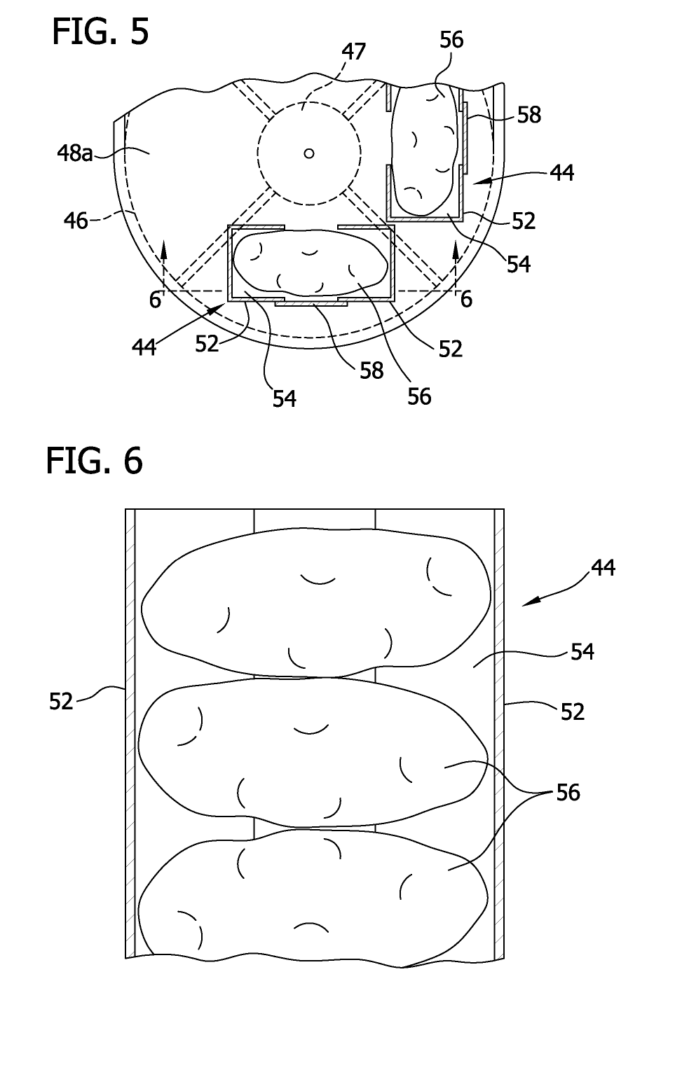

The slicing mechanism 14 preferably comprises a base member or carriage 40 with carriage wheels 42, potato holders or hoppers 44, a blade member 46, and a blade drive motor 47. The base member 40 is configured and adapted to connect and support the other components of the slicing mechanism 14, and includes upper and lower rigid plate members 48a and 48b that are spaced apart and parallel to each other and rigidly connected to each other by a plurality of posts or column members 50. The blade member 46 is disc-shaped and preferably comprises a plurality of radially disposed blades in a manner similar to a food processor. The blade drive motor 47 is fixed to the bottom plate member 48b to rotationally drive the blade member 46 beneath the upper plate member 48a. The potato holders 44 are similar to each other, and each comprises a pair of opposed C-shaped channel members 52 so as to form elongated generally rectangular slots 54 into which potatoes 56 can be vertically stacked therein, as shown best in FIGS. 5 and 6. Each potato holder 44 also has upper and lower sections with a hinge 58 that allows the potato holder to be folded down ninety degrees to thereby facilitate the transportation and storage of the potato chip production device 10.

The carriage 40 of the slicing mechanism 14 is preferably mounted on the support rack 24 of the main body portion 12 of the potato chip production device 10 by its wheels 42 which have an outer annual V-groove that rides along guide rails 28a and 28b of the support rack. The slicing mechanism 14 is also threadly attached to the drive rod 30 of the support rack 24 such that the carriage 40 translates horizontally along the guide rails (28) in response to rotation of the drive rod 30. Additionally, the blade drive motor 47 is operatively connected to and controlled by the electronic control unit 26.

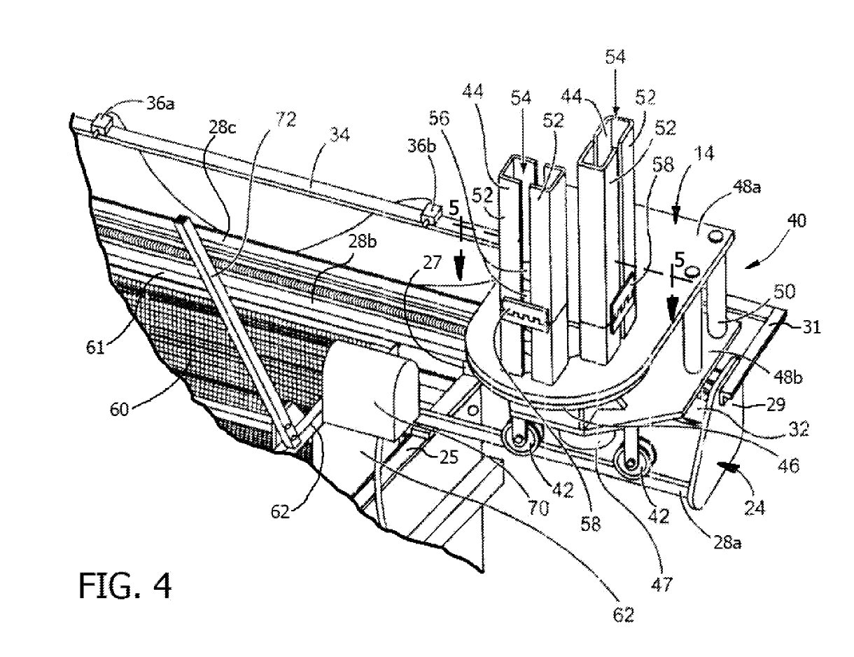

The form of the strainer 16 shown in FIGS. 1-4 comprises a mesh basket or screen bin 60 having a semi-cylindrical bottom portion and flattened upper side portions with a rigid support frame 61 having opposed end walls 62, intermediate ribs 63 and a pair of cantilevered support beams 64. In the embodiment form of FIGS. 1-7, the strainer also has a mesh mixing paddle 66 (shown only in FIG. 3) and a mixing paddle drive motor 70, and a dumping lever 72. The strainer 16 has a dimension slightly smaller than that of the cooking oil container or vat 18 to be lowered position therein during the cooking sequence. The end walls 62 of the support frame 61 partially bound the mesh bin 60 and ribs 63 maintain the shape of the mesh bin. The mixing paddle 66 is positioned within the mesh bin and is rotationally connected to extend between the end walls 62 on an axis parallel to the direction of reciprocating movement of the slicing mechanism. The mixing paddle drive motor 70 attached to one of the support beams 64 is operatively connected to the mixing paddle 66 and the electronic control unit 26 periodically rotates the mixing paddle within the mesh bin 60 to stir the chips during the cooking sequence. In the FIGS. 1-4 embodiment the support beams 64 are pivotally attached, at 69, to a pair of screw jacks 68 in a manner allowing the strainer 16 to pivot at least ninety degrees (FIG. 3), relative to the screw jacks. The screw jacks 68 are positioned on the front side of the potato chip device 10 between the exterior paneling 32 and the cooking oil container 18 of the main body portion 12 and attach the strainer 16 to the main body portion. Additionally, the screw jacks 68 are operatively connected to the electronic control unit 26 and are electromechanically driven so as to vertically extend and retract so that the strainer is raised out of and lowered into the cooking oil container 18. Finally, the dumping lever 72 is rigidly connected to provide a handle and lever-arm for manually pivoting the mesh bin 60 relative to the screw jacks 68 toward the front side of the potato chip apparatus 10. Although the embodiment of FIGS. 1-3 disclose the use of dual screw jacks 6 to raise and lower the strainer means 16, it has been determined that a single jack or like control means for vertically positioning the strainer is adequate and may be desirable in certain operating situations.

In addition to the above mentioned components of the potato chip production device 10, the device may also include a potato chip collection assembly 74, as shown in FIG. 3, which preferably comprises a collection tray 76 and two support arms 78. The support arms 78 are configured to be removably attachable to the main body portion 12 of the potato chip production device 10 in a manner such that they cantilever therefrom. The potato chip collection tray 76 is dimensioned to be at least as long as the mesh bin 60 and to be supported by the cantilevered support arms 78. Clearly the chip collection tray 76 is constructed and arranged to receive the deep-fried potato chips from the mesh basket 60 for seasoning and processing, which may include a dehydration process to be described.

In operation, the potato chip device is operated by first heating the cooking oil within the container 18 to an acceptable temperature. Such a temperature may vary depending upon the type of oil used and the type of potato and thickness of potato chips being produced. However, in the production of long sliced huge potatoes, such as Russet and Alturas, the preselected starting temperature will be in the range of 315° F. to 320° F. to obtain a rapid cooking “set” of the moist, starchy surfaces of the fresh potato slices. It will be noted that supplemental heat is provided during the allocated set period of about three minutes, and the cooking oil temperature is then permitted to drop down to a deep frying “cook” temperature in the range of 275° F. to 290° F. because of the volume of potato slices. If the cooking oil temperature drops below 275° F. before the prescribed total cook time of about seven minutes has expired, the burner or other heat source is kicked on again to maintain a minimum oil temperature to finish the cooking sequence. Desirably the heat source is controlled by the electronic control unit to coordinate with its other batch control functions, as will appear; but, it may be controlled by a separate thermostat that monitors the temperature of the cooking oil.

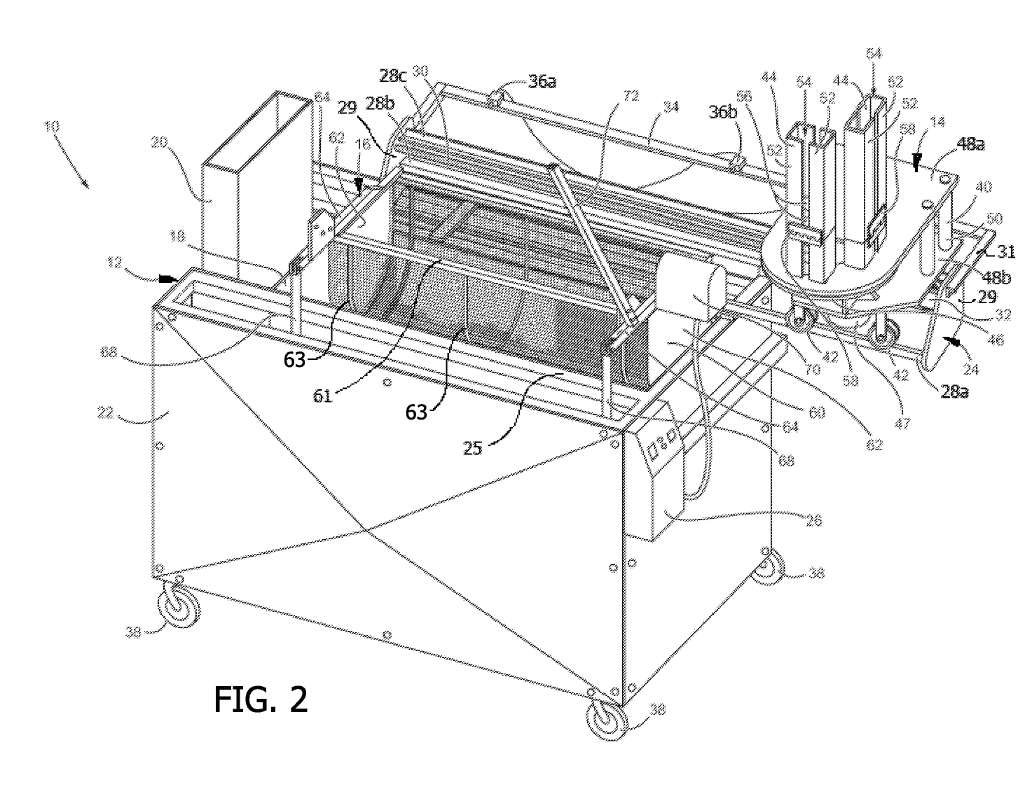

Prior to activating the electronic control unit to begin producing potato chips, pre-cleaned whole raw potatoes are loaded into the vertical slots 54 of the potato holders or hoppers 44 on the slicing mechanism. The rectangular configuration of the slots allow the potatoes to be oriented with their longest dimension generally parallel to the plane of the blade member 46 such that the chips being produced are as large as possible i.e. long-sliced from end to end. During this step, the slicing mechanism is positioned at the cantilevered end of the support rack 24 in the inoperative loading position, as shown in FIGS. 2 and 3, and the mesh basket is lowered into the hot cooking oil at its starting temperature of about 317° F.

With the above-mentioned steps performed, the electronic control unit 26 can be activated to automatically produce deep-fried potato chips. The electronic control unit activates the drive rod motor 32 to rotate the drive rod 30 and cause the slicing mechanism carriage to move from its remote loading station toward the opposite end of the support rack. As the slicing mechanism moves over the cooking oil vat 18, it triggers the middle sensor 36b on the support rack which, via the electronic control unit, causes the blade drive motor 47 to begin rotating the slicer blade member 46. It may be noted that the weight of the vertically stacked whole raw potatoes 56 in the holders 44 causes gravity to feed the raw potatoes into the rotating slicer member 46, which slices the raw potatoes longitudinally into raw potato slices or chips. As this occurs, the slicing mechanism carriage continues translating or moving along the rear side of the oil container 18 until it reaches the sensor 36a at the opposite remote end from which it started. Upon receiving a signal from this limit switch sensor, the electronic control unit 26 reverses the direction of the drive rod motor 32 and thus the return direction of translation of the slicing mechanism carriage. Eventually, the slicing mechanism once again triggers the middle sensor 36a, which in response thereto, again reverses the direction of the drive rod motor and hence, the direction of the slicing mechanism. This reversing or reciprocating action continues such that the slicing mechanism moves horizontally back and forth along the cooking oil container. After a preprogrammed amount of time, usually about two minutes, or number of reciprocated passes, the blade drive motor is turned off and the middle limit switch 36b is deactivated so the slicing mechanism is allowed to move back to its original parked or loading position where the last sensor 36c triggers the electronic control unit to shut off the drive rod motor and blade drive motor 47.

It should be appreciated that while this slicing sequence is occurring, the raw potato slices fall by gravity into the mesh bin 60 of the strainer means 16 where they are immersed in the cooking oil. It may also be noted that the potato holders 44 are arranged at the front and trailing quadrants of the slicing mechanism whereby the potato chips will be sliced during the forward arc of rotation of the slicer disc 46 and thus the cut raw potato slices will be released in a forward and laterally outward direction. The slicing machine carriage 40 is tilted toward the cooking oil container because the back rail 28b is elevated by risers 27 higher than the front rail 28a. This angularity of the slicing plane of less than twenty degrees relative to the longitudinal movement direction of the potatoes (and bath of cooking oil) is believed to be a factor in the gravity fall of the cut raw potato slices away from the slicing mechanism and into the cooking oil. It should also be appreciated that the reciprocating movement of the slicing mechanism during this slicing step causes the raw potato slices to fall into the cooking oil in a dispersed or scattered manner so as to prevent them from sticking to each other during the initial set period of cooking.

After slicing and following the set period during the cooking stage of production, the mixing paddle 66 is intermittently rotationally driven by the mixing paddle drive motor 70 and the electronic control unit 26 to help prevent the uncooked potato surfaces from sticking to each other during the remaining cooking process.

After a preselected amount of cooking time (about seven minutes), the electronic control unit activates the screw jacks 68 to verbally extend and thereby lift the strainer out of the cooking oil as shown in FIGS. 2 and 3. This stops the cooking process. It should be appreciated that the determined amount of time as well as specific temperatures is based on the particular potato variety used for converting the raw potato slices into deep-fried potato chips. It should further be appreciated that by moving the slicing member carriage back to its original offset loading position, the slicing mechanism is no longer in a position to interfere with the mesh bin, and is now conditioned for re-loading with a new batch of potatoes.

When the mesh bin 16 with the fully cooked chips is fully raised, the control unit 26 switches to a paused mode where all movable components remain stopped in their current positions and residual surface oil from the cooking process can drain from the strainer and chips therein. At this point and with the mesh bin raised and the potato chips removed from the cooking oil, the person operating the potato chip production device can then actuate the dumping lever of the strainer downwardly to thereby pivot the mesh bin about the hinging connection between the screw jacks and the support beams of the strainer. As such, the mesh bin of the strainer pivots from the position shown in FIG. 2 to the position shown in FIG. 3. This allows the deep-fried potato chips to cascade onto the collection tray 76 of the potato chip collection assembly in a waterfall like manner. If all of the chips do not fall freely, the rest can be removed from the mesh bin by a tool such as a spatula or rake.

After the potato chips have been removed from the mesh bin and are positioned in the collection tray, seasoning is preferably added to the deep-fried potato chips. The application of such seasoning is facilitated by the collection tray configuration and the fact that the potato chips are removed from the elongate mesh bin in a spread-out manner and are distributed the full length of the collection tray and are not significantly piled on top of each other. This makes the seasoning process, which is typically performed manually using a hand shaker, fairly simple and even. With the deep-fried potato chips seasoned, the potato chips are ready for consumption and the collection tray can be lifted from the support arms 78 of the potato chip collection assembly 74 and then the chips can be transferred therefrom into some other container or from which individual servings of the chips can be obtained.

During the seasoning process or at anytime following the slicing sequence, the potato chip production device 10 can be reloaded with raw potatoes so the control unit can be reactivated to begin the entire batch cooking process over again. Upon reactivation, the control unit 26 first lowers the strainer 16 back into the bath of heated oil which has been reheated to its starting or “set” temperature and it then repeats the process steps discussed above. Thus, the potato chip production device can be reactivated to produce as many batches of chips as desired.

One aspect of the invention is that the potato chip production device of the invention can be operated to produce potato chips at or near their point of sale or place of consumption. The operation of the potato chip production device at a fair, amusement park, or other type of public setting will provide a marketing advantage over other food items for sale. In other words, operation of the production device in close proximity to the point of sale of the potato chips, enhances the marketing potential and entices people to purchase the chips. Also, the wheels 38 on the main body frame assembly 12 allow the production device to be easily transported over the surface on which it is supported. This is beneficial in situations such as when the production device is utilized at fairs or other locations where it must be brought on site and removed relatively soon thereafter. To this end, the production device is dimensioned such that it can be loaded onto a standard full-size pickup truck bed or onto a small trailer for transportation to a different event at a different location.

Those skilled in the culinary arts will understand that every food substance has its own physical qualities and taste attributes that require special knowledge and skilled effort to produce an excellent gourmet product uniquely distinguishable from ordinary unimaginative everyday cooking. Potatoes are perhaps the world's most favorite and widely used starch product (other than rice) and are very versatile and adaptable to a wide range of cooking techniques—and potato chips (“crisps”) are a recognized favorite form, as previously indicated at the outset. In development efforts striving for optimum performance in producing the largest “gigantic” or “colossal” and best potato chips, it has been discovered that a higher production level of quality chips can consistently be achieved with further improvements in several areas, including temperature control, changed cooking environment and by adding a dehydration step.

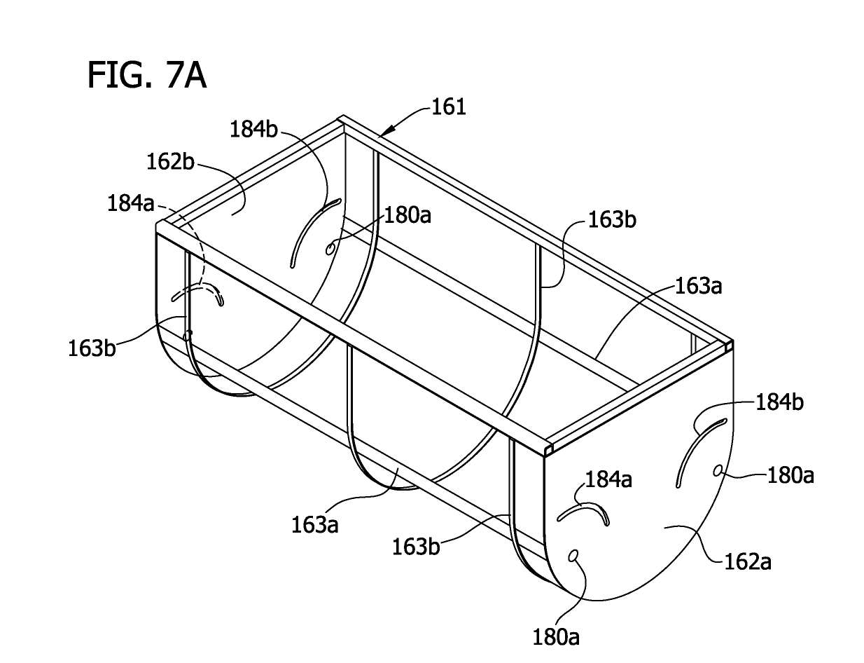

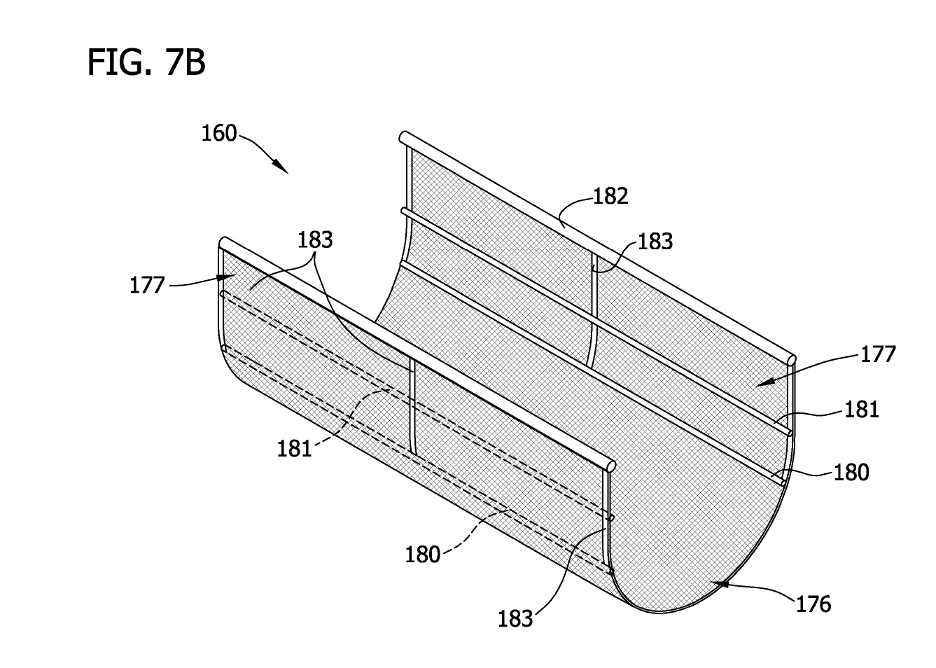

Referring to FIGS. 7-11, the improved method of carrying out the cooking sequence for deep-frying the potato slices is facilitated by a novel collapsible or foldable wire mesh basket arrangement in addition to improved temperature regulation of the cooking oil. In this embodiment, the vat or container (18) of cooking oil is mounted in the main body (12) of the potato chip production apparatus (10) in the same relationship to the slicing mechanism (14) as that of the FIG. 1-3 embodiment. However, the strainer 116 is modified to improve the cooking method and more consistently produce high quality fried chips.

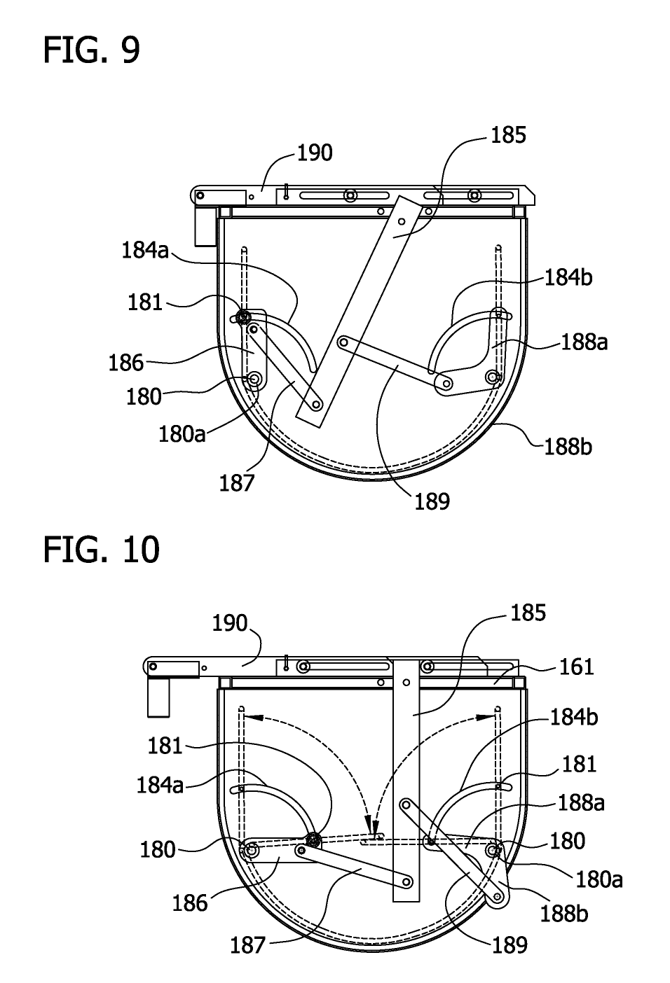

The strainer 116 comprises a rigid support frame 161 (FIG. 7A), and a screen bin or mesh basket 160 (FIG. 713) contained within and carried by the support frame 161. The mesh basket 160 has a semi-circular bottom wall portion 176 and flattened upper side wall portions 177 and the support frame 161 is constructed and arranged to form a complementary cradle represented by its end panels 162a and 162b. These end panels are connected in spaced relation by an elongate top rail frame 163 and spaced longitudinal side straps 163a, and intermediate U-shaped reinforcing ribs 163b are provided (FIG. 7A). Referring to FIG. 7B, the mesh basket 160 is shaped to conform to the ribbed cradle formed by the support frame 161. The improved cooking method calls for the upper side wall portions of the mesh basket to be foldable inwardly and downwardly from the vertical open slice-receiving position (FIG. 9) to the lowered horizontal position of (FIG. 10) in which these side walls form a closure across the cooking oil to enfold and depress the cooking potato slices downwardly within the oil and maintain the slices in this cooking environment to the end of the cooking sequence. The timing of the slicing and scattered dispersal of the potato slices across the cooking oil surface in the open basket position correlates to the critical first cooking stages of the potato slices, called the “set” time or period. It is known that fresh slices of a raw potato are extremely moist and starchy and will tend to adhere to each other by surface tension and form “glumps” instead of discrete individual chips so the initial set time is critical in carrying out the method.

The traveling slicing mechanism (14) takes about 2 minutes to slice about 20 pounds of large Russet potatoes and disperse them in a scattered pattern across the oil surface. At the start of the cooking sequence when slicing begins the oil temperature is at its set temperature of about 315° to 320° F. The raw slices will initially sink into the hot oil and begin to fry as the moist surface starch is cooked to its “set.” Condition. The duration of the “set time” from the start of slicing activity is about three minutes during which set slices begin to float back to the surface of the cooking oil. In the first disclosed embodiment of FIGS. 1-3, a stir paddle (66) was intermittently driven to keep the cooking chips dispersed through the oil bath. However, it has been determined that stirring or other agitation of the cooking oil is counterproductive to the extent that some of these large chips can become folded on themselves or broken with a consequent undesirable shrinkage in production.

According to the improved method hereof the foregoing adversity is obviated in part by eliminating the stirring paddle and submerging the cooking slices entirely beneath the surface of the cooking oil. To that end, FIG. 7A-FIG. 10 show that this method can be performed in one embodiment by folding down the side walls 177 laterally across the cooking vat to push down on the floating “set” chips and depress them below the oil surface in a submerged condition for the remaining cooking or “soaking” period. Thus the upper wall segments 177 are constructed and arranged as hinged gates that can be moved between the open position for slicing and chip removal and the lowered horizontal or closed chip cooking position. The enfolding or hinging of the side walls 177 is implemented by forming each side wall gate 177 with a rigidifying frame that included a longitudinal actuator bar 180 having its ends rotationally journalled, at 180a, in the support frame end plates 162a and 162b, a longitudinal alignment guide bar 181 having its ends slidably engaged in arcuate guide slots 181a in the opposing support frame end panels 162a and 162b. The side wall portions are suitably framed out—as by a top bar 182 and vertical connectors 183 to the actuator and alignment bars 180 and 181 to rigidify these movable wall sections.

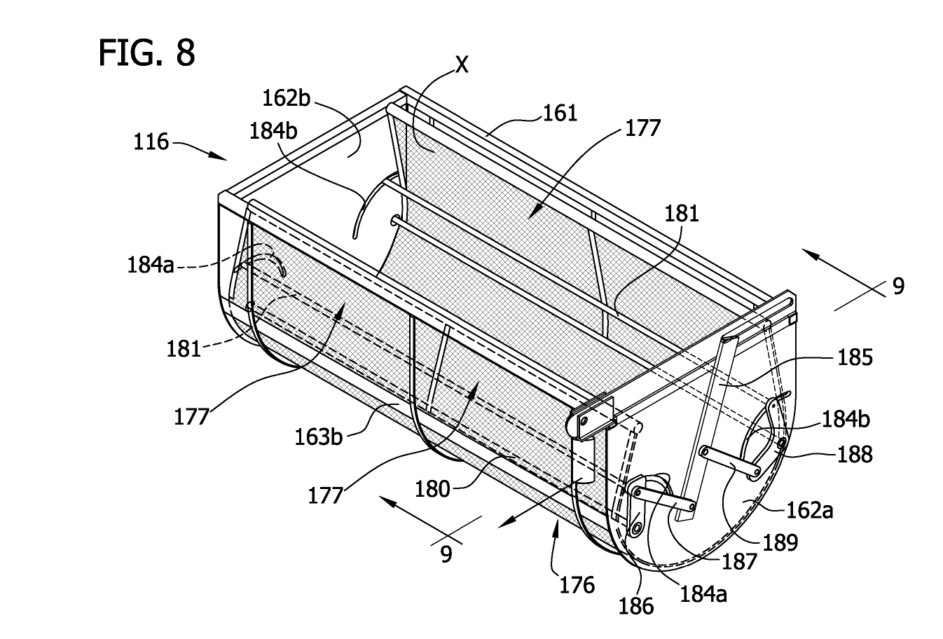

Still referring to FIGS. 7A and 8-10, the control action for folding the side wall portions 177 to envelope the cooking chips may be provided through a control linkage. Each end panel 162a and 162b has a pair of corresponding arcuate left-hand and right-hand guide slots 184a and 184b to slidably receive the outer ends 181a of the alignment guide rods 181 and guide the folding action of the respective side walls from the open slicing and post-cooking removal stages to the closed cooking or soak stage of the chips. This chip enfolding action, FIGS. 8-10, utilizes a linkage control from a central vertically-extending arm 185 to the respective journalled ends 180a of each bar 180. As shown, the left-hand side wall has a control link 186 secured to the ends of actuator rod 180 and alignment rod 181, and the control link 186 has a control lever 187. The other side wall 177 has the ends of its alignment bar 181 slidably received in arcuate guide 184b, and the journalled end 180a of actuator bar 180 is secured to bell crank 188 having one crank arm 188a secured to the ends of side wall alignment bar 181 and its other crank arm 188b connected by control lever 189 to the control arm 185. From FIGS. 9 and 10 it will be clear that manipulation of a horizontal plunger 190 along the top frame 161 will rock the vertical control arm 185 to close (FIG. 10) and open (FIG. 9) the side wall gates 177 through their respective linkages.

It will now be clear that the cooking process starts with the cooking oil in vat (18) at its starting temperature of 315° F. to 320° F. and the side wall gates 177 of the mesh basked 160 in the open vertical position (FIG. 9) as the potato slices are cut during reciprocating movement of the slicing mechanism (14). When the set time of about three minutes expires the side wall gates 77 are closed downwardly across the vat to enfold and depress the set slices downwardly into the bath of cooking oil for the remaining cooking sequence or soak time of about four minutes at which time the electronic control raises the strainer vertically above the cooking oil to provide a drain sequence and the side walls are again raised to the open vertical position for chip removal. At this time the control is programmed to turn on the heater means to bring the cooking oil temperature back up to its higher starting setting.

After the chips are removed into the collection tray 74 for seasoning and other processing, the strainer means (16) is returned to its lowered position (FIG. 1) within the vat and the apparatus is in its paused or standby mode for processing another batch of potatoes.

A further improvement in the method of the invention resides in putting the seasoned potato chips through a dehydrating or drying sequence. It has been determined that a supplemental moisture absorption process enhances the quality of the finished potato chips by removing excess surface oil and/or moisture from the chips. Thus the chips in the tray 74 are transferred to another wider absorption tray (not shown) having a liner of heavy paper or other absorptive material, and this tray is placed in a ventilated drying station (not shown) that is a closed chamber having a temperature of about 140° F. and a high volume, but low velocity circulating air flow and drying the chips for about twelve hours. The removal of oil and moisture into the brown paper liner or the like is a positive factor in reducing the discard percentage of poorer quality chips from about 20% to 30% down to a 3% to 5% level. After the absorption process the chips are removed for packaging and/or sale.

It should be understood that all matter contained in the above description or shown in the accompanying drawings is intended to be interpreted as illustrative and not in a limiting sense and that various modifications and variations of the device and methods may be employed without departing from the scope of the invention defined by the following claims. For example, it should be appreciated that, although the heat source of the potato production device preferably operates via propane, the heat source could alternatively produce heat from any other source, such as electricity. Moreover, the performance of some production steps to a consumer, unless required by any particular claims, needs not necessarily be visible at the point of sale. Thus, other possible variations and modifications of the production device and its method of use should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, to the extent the term “portion” is used in the claims or is added by amendment, such term should be construed as meaning some or all of the item or element that it qualifies.

What is claimed is:

1. A method of making long-sliced deep-fried potato chips from whole, raw potatoes having an elongate shape comprising:
providing a horizontally elongated mesh strainer in a vat holding a bath of cooking oil and heating the cooking oil to a pre-selected frying temperature;
loading the potatoes into a slicing mechanism at one end of the vat of cooking oil with the long potato dimension being oriented to correspond to that of the mesh strainer;
moving the slicing mechanism back and forth over the vat of cooking oil and concurrently slicing the potatoes in the long dimension thereof to dispense raw potato slices to fall into the cooking oil in a scattered manner;
deep-frying the potato slices into deep-fried potato chips during a controlled cooking sequence and then removing the mesh strainer from the cooking oil.

2. The method of claim 1 including reciprocating the slicing mechanism back and forth along the vat of cooking oil to produce the raw potato slices within a slicing time sequence of about two minutes.

3. The method of 2 in which the cooking sequence includes an initial set time in which the starchy moist surface condition of the freshly cut raw potato slices is cooked to a set condition, and a sequential soak time in which the potato slices are fully cooked to the deep-fried condition.

4. The method of claim 3 including cooking the potato slices for a set time of about three minutes and a soak time of about four minutes.

5. The method of claim 4, in which the pre-selected frying temperature is in the range of about 275° F. to 320° F.

6. The method of claim 5, including controlling set time temperature of the cooking oil within the range of about 315° F. and 320° F., and maintaining a minimum soak time temperature of the cooking oil at about 275° F.

7. The method of claim 4 including providing the strainer with means for enfolding and submerging the potato slices within the cooking oil during the soak time of the cooking sequence.

8. The method of claim 7 in which said means for enfolding comprises moving upper side wall portions on the strainer downwardly to a closed position across the heated cooking oil.

9. The method of claim 8 including moving the strainer side wall portions to an open position in the vertically elevated position of the mesh strainer after the cooking sequence of deep-frying potato chips.

10. The method of claim 1 including emptying the deep-fried potato chips from the mesh strainer onto a seasoning station and applying seasoning thereto.

11. The method of claim 10 wherein the emptying step is carried out by rotating the mesh strainer to cause the deep-fried potato chips to fall by gravity onto a chip collection tray.

12. The method of claim 10 including the further step of dehydrating the deep-fried potato chips on an absorbent surface.

13. The method of claim 12 which includes the step of carrying out the dehydration step in a controlled atmosphere in a drying chamber at a temperature of about 140° F., and circulating a high volume of air at a low velocity through the dry chamber for about twelve hours.

14. The method of claim 1, wherein the step of removing the deep-fried potato chips from the cooking oil comprises automatically raising the mesh strainer to lift the deep-fried potato chips above the cooking oil, the method further comprising providing a drain-time sequence and then rotating the strainer to discharge the deep-fried potato chips to fall by gravity from the mesh strainer onto a chip collection tray.

15. The method of claim 1 where in the step of moving the slicing mechanism is carried out in a horizontal plane parallel to the surface of the heated cooking oil and the step of slicing the raw potato slices is preformed at an angle of less than twenty degrees relative to the horizontal plane of movement.

16. The method of claim 1 wherein the step of removing the deep-fried potato chips further comprises rotating the strainer device about an axis that is parallel to the direction of back and forth movement of the slicing mechanism in a manner causing the fried potato chips to fall by gravity onto a chip collection tray.

17. The method of claim 1 in which the method further comprises displaying the loading, slicing and the removing steps to potential consumers to entice the potential consumers to purchase the deep-fried potato chips, the displaying being by direct line-of-sight.

18. The method of making long sliced potato chips from whole, raw potatoes having an elongate shape, comprising:
providing a potato chip production device having a slicing mechanism, a bath of heated cooking oil, a strainer and an electronic control unit,
positioning the strainer in a lowered position within the bath of cooking oil;
loading a plurality of the whole, raw potatoes into the slicing mechanism in a vertically stacked relationship with the long dimension thereof being oriented to extend in the same direction;
activating the electronic control unit to initiate and control movement of the slicing mechanism from a remote inoperative loading position through an operative slicing sequence above the bath of heated cooking oil,
operating the slicing mechanism in its operative slicing sequence to slice across the bottom surface of the stacked potatoes in a series of sweeping cuts through the long dimension of the potatoes to thereby dispense the plurality of raw potato slices in a scattered manner across the surface of the bath of heated cooking oil;
cooking the raw potato chips in the heated cooking oil at predetermined conditions in a cooking sequence to produce fresh deep-fried potato chips,
raising the strainer to lift the deep-fried potato chips from the heated cooking oil so that the strainer is positioned over the heated cooking oil to thereby provide an oil-draining sequence; and
processing the fresh deep-fried and drained potato chips for seasoning and marketing.

19. The method of claim 18 in which the method further comprises displaying the loading, slicing and the removing steps to potential consumers to entice the potential consumers to purchase the deep-fried potato chips, the displaying being by direct line-of-sight.

20. An apparatus comprising:
a cooking oil container containing a bath of cooking oil;
a heat source adapted to provide heat to the bath of cooking oil;
a potato slicing mechanism constructed and arranged to slice raw potatoes, the potato slicing mechanism being operatively oriented with the cooking oil container for reciprocating movement over the bath of cooking oil;
a strainer associated with the cooking oil container and mounted for movement into and out of the bath of cooking oil; and the potato slicing mechanism and the strainer in a manner such that the electronic control unit is adapted to control the reciprocating movement of the potato slicing mechanism and the movement of the strainer.

21. The apparatus of claim 20 wherein the potato slicing mechanism comprises a holder and a cutting blade, the holder being dimensioned to hold and orient a plurality of elongate raw potatoes to be fed into the cutting blade in a manner such that the longitudinal dimension of each respective potato is kept oriented through the slicing action of the cutting blade of the potato slicing mechanism.

22. The apparatus of claim 20 in which said strainer includes means for enfolding and depressing partially cooked potato slices downwardly into the bath of cooking oil to complete a cooking sequence for producing deep fried potato chips.

23. The apparatus of claim 22 including means for transferring the deep-fried potato chips from the strainer to a collection station, and other means for drying the potato chips to remove cooking oil and moisture.

24. A potato chip making apparatus for making long sliced potato chips from whole, raw potatoes having an elongate shape, said apparatus comprising a slicing mechanism, a cooking station, a deep-fried potato chip removing mechanism and an electronic control unit;
Said slicing mechanism including potato holder means for holding a plurality of whole, raw potatoes in a vertically stacked relationship with the long dimension thereof being oriented to extend in the same direction, slicer means constructed and arranged below said potato holding means and operable for slicing across the bottom surface of the stacked potatoes therein in a series of sweeping cuts to thereby sequentially make a plurality of elongate raw potato slices, carriage means for supporting said potato holder means and slicer means, and carriage drive means for moving the carriage means from a remote potato loading station along an elongate slicing station superposed over the cooking station, and said control unit including means for moving said carriage means back and forth in a reciprocating action over the cooking station in a controlled slicing sequence, and means for operating said slicer means only during said reciprocating sequence whereby the sequentially made raw potato chip slices are dispensed in a dispersed manner;
said cooking station including a container vat having a long dimension and being constructed and arranged to hold a bath of heated cooking oil for receiving the raw potato chip slices as they are dispersed from the slicing mechanism by the slicing action thereof, heating means for heating the batch of cooking oil to produce deep-fried potato chips;
said potato chip removing mechanism including strainer means for containing the potato chip slices within the bath of cooking oil, lifting means for raising the strainer means above the cooking oil, and said control unit being operable to terminate the deep-frying sequence by operating the lifting means.
